(19) United States
(12) Patent Application Publication
(10) Pub. No.: US 2006/0022443 A1
(43) Pub. Date: Feb. 2, 2006

(54) Gas generator containing a flash suppressant

(76) Inventors: Bruce A. Stevens, Oakland, MI (US); Steven Maxwell Gordon Dunham, Mt. Clemens, MI (US)

Correspondence Address: L.C. BEGIN & ASSOCIATES, PLLC, 510 HIGHLAND AVENUE, PMB 403, MILFORD, MI, 48381, US

(21) Appl. No.: 10/940,395

(22) Filed: Sep. 13, 2004

Related U.S. Application Data
(60) Provisional application No. 60/591,314, filed on Jul. 27, 2004.

(51) Int. Cl. B60R 21/26

(52) U.S. Cl. 280/736

(57) ABSTRACT

Flame suppressants or catalysts, independent of the gas generant composition, reduce the flame front and carbon monoxide produced by combustion of gas generating compositions employed within gas generating systems such as vehicle occupant restraint systems, for example. Heterogeneous distribution of the flash suppressant and the gas generant within the gas generant bed facilitates, upon gas generator activation, a reduction in flame front of any known gas generant without reformulating the gas generating composition.

### CROSS REFERENCE TO RELATED APPLICATIONS

This application claims the benefit of U.S. Provisional Application Ser. No. 60/591,314 filed on Jul. 27, 2004.

### BACKGROUND OF THE INVENTION

Micro gas generators useful in vehicle occupant protection systems, within seatbelt pretensioners for example, typically use nitrocellulose or other pyrotechnic gas generants or propellants to generate gas for activating devices such as seatbelt pretensioners. When actuated, gas generators often produce a flame front potentially resulting in damage to the surrounding housing and gas generating assembly. Seatbelt pretensioners, for example, are often damaged beyond repair or, damaged and thereby substantially reducing the salvage value of the seatbelt assembly. Accordingly, after a crash event, the seatbelt pretensioner or seatbelt assembly may require overall replacement rather than simple replacement of selected parts. Other gas generator applications including airbag inflators, and lifeboat or aircraft inflatables also may exhibit the same flame front combustion phenomenon. Because of potential disadvantages relative to the existence of flame, such as the integrity of the seal in an inflatable lifeboat for example, other applications would benefit from gas generant compositions that did not result in the flame front propagation normally attendant when many known gas generant compositions are combusted.

Yet another concern is the production of carbon monoxide upon gas generant combustion, particularly with regard to the use of carbon-containing propellants such as nitrocellulose. Although desirable because of its cost and because of its ability to produce required amounts of gas, nitrocellulose and other gas generants may produce undesirable amounts of carbon monoxide in certain gas generant applications.

### SUMMARY OF THE INVENTION

In accordance with the present invention, a solid or powdered flame suppressing additive, selected from the group including manganese dioxide/copper oxide catalyst, palladium or other transitional metal catalysts and oxides thereof, and mixtures thereof, is added to a propellant bed inside a typical micro gas generator or any other gas generator. The propellant bed therefore contains a primary propellant, and the flame or flash suppressing agent is essentially sprinkled or commingled amidst the propellant in heterogeneous relationship therewith. Stated another way, any known propellant may incorporate a flame suppressant additive within the propellant bed wherein the propellant and the additive constitute distinct solid phases within the propellant bed given that the flame suppressant is added separately from the gas generant.

In practice, any gas generator may include the additive contained in the propellant bed and added during manufacture of the gas generator. The additive is applied directly over and within the propellant or nitrocellulose bed thereby mitigating the flame and flash front propagation of the propellant upon combustion thereof. Accordingly, in a preferred embodiment, the additive may be heterogeneously interspersed about the nitrocellulose or any other propellant suitable for use within a gas generator for vehicle occupant protection systems whereby the primary propellant and the additive are essentially different contiguous phases of a solid mixture.

### BRIEF DESCRIPTION OF THE DRAWINGS

FIG. 1 is a typical airbag inflator system comprising a propellant bed, a gas generant, and a flame suppressant in accordance with the present invention.

FIG. 2 is a gas generating system comprising an inflator, wherein the gas generating system is a vehicle occupant protection system in this embodiment.

FIG. 3 is a sectional view of a typical seatbelt pretensioner containing a micro gas generator, the gas generator containing a propellant and a flame suppressant in accordance with the present invention.

FIG. 4 is a view of a seatbelt pretensioner of FIG. 3 mechanically coupled to a seatbelt reel wherein the seatbelt pretensioner contains a propellant and a flame suppressant in accordance with the present invention.

FIG. 5 is a schematic view of a gas generating system containing a seatbelt pretensioner in accordance with the present invention, wherein the gas generating system is a seatbelt assembly in this embodiment.

### DETAILED DESCRIPTION OF THE INVENTION

In accordance with the present invention, a gas generant known for its utility in various safety systems within automobiles, aircraft, and/or sea crafts for example, is housed within a gas generator also known for its utility in the respective application. A vehicle occupant protection system exemplifies a typical environment or gas generating system that houses one or more gas generators or inflators employing the present invention. A typical airbag inflator as exemplified in U.S. Pat. Nos. 5,934,705, 6,422,601, 6,547,277, or any other known airbag inflator may incorporate any known gas generant also recognized for its utility in an airbag inflator. U.S. Pat. Nos. 5,035,757, 6,074,502, 6,210,505, 6,306,232, and other known airbag inflator propellants exemplify, but do not limit the gas generant compositions believed useful in the context of the present invention. Each patent discussed herein is incorporated by reference in its entirety.

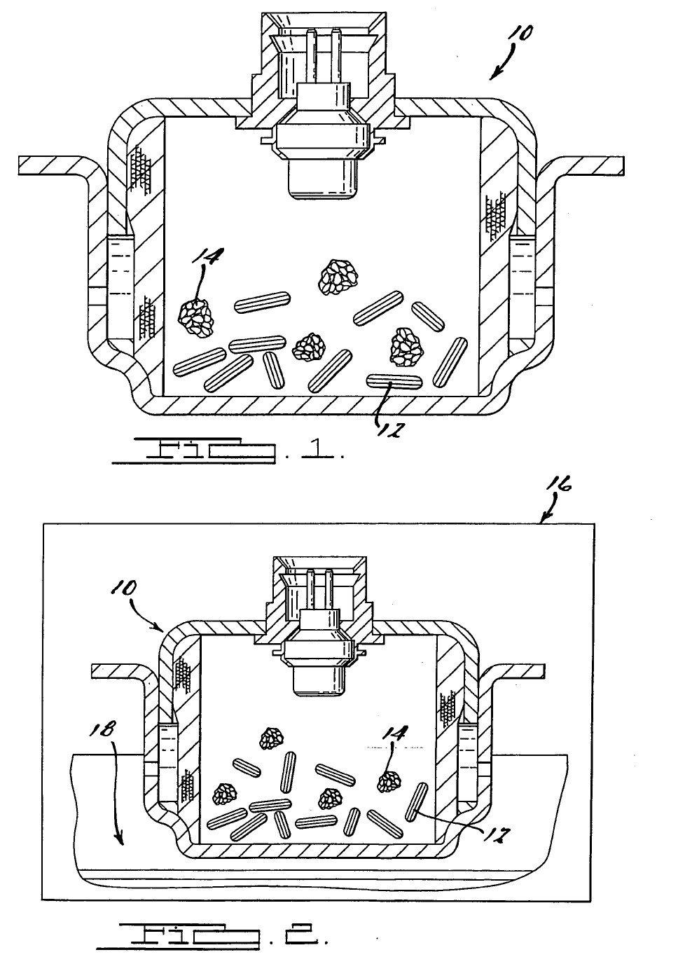

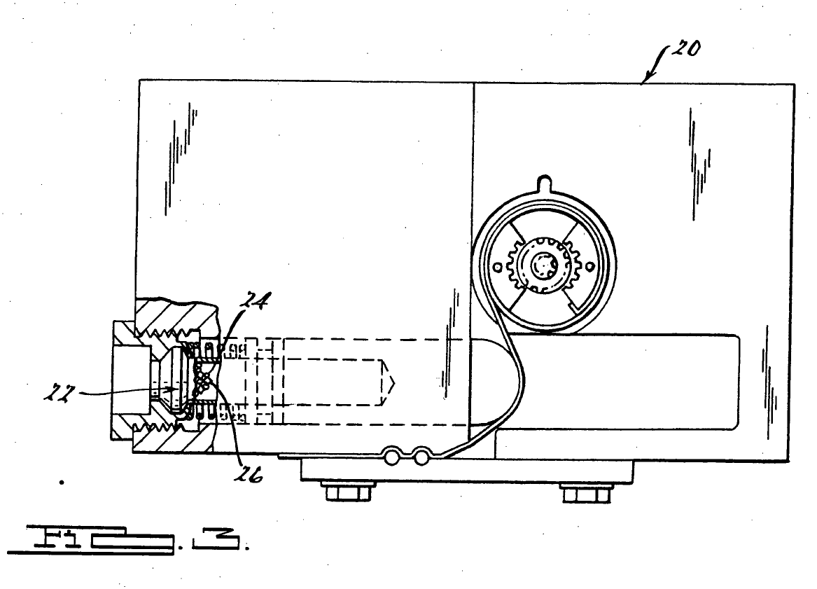

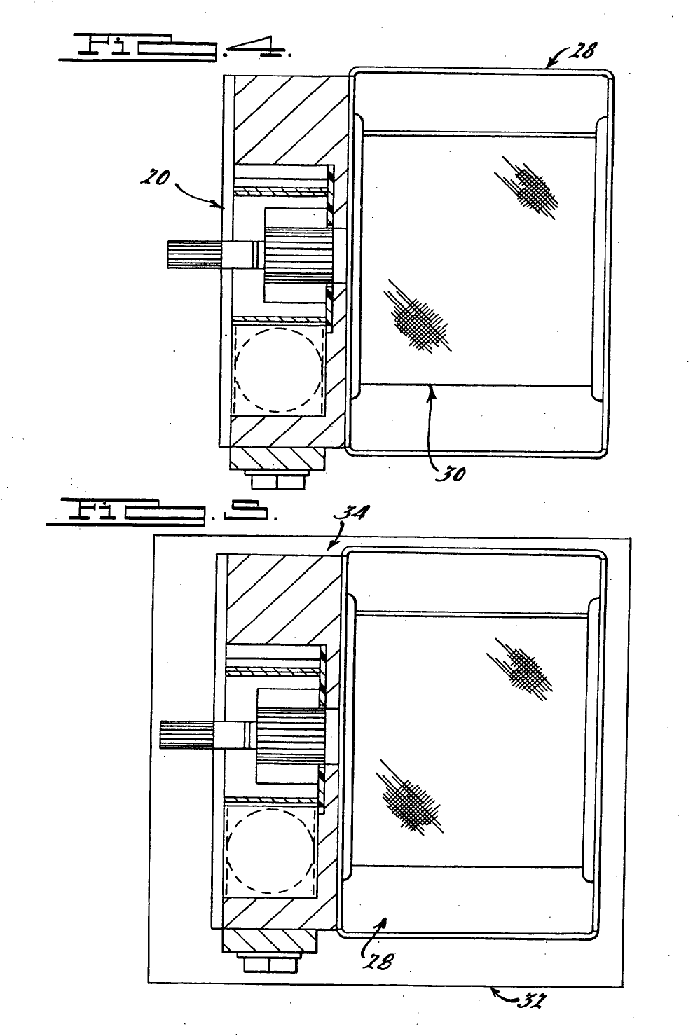

FIG. 1 exemplifies a typical airbag inflator 10 containing a primary gas generant 12 and a flame suppressant 14 in heterogeneous relation therewith. FIG. 2 exemplifies a gas generating system 16 including the airbag inflator 10 and an airbag 18 inflated upon gas generator 10 activation. Although not hereby limited, the gas generating system 1 6 is representative of a typical vehicle occupant protection system as otherwise known in the art. FIG. 3 exemplifies a typical seatbelt pretensioner 20 containing a micro gas generator 22 containing a propellant 24 and a flame suppressant and/or carbon monoxide reducing catalyst 26. FIG. 4 illustrates a seatbelt assembly 28 containing the seatbelt pretensioner 20 of FIG. 3 mechanically coupled to a seatbelt reel 30. FIG. 5 exemplifies a gas generating system 32 including the seatbelt assembly 28. Although not hereby limited, the gas generating system 32 is representative of a typical seatbelt assembly 28 or in the alternative, a vehicle occupant protection system 34 containing the seatbelt assembly 28 wherein the vehicle occupant protection system is otherwise manufactured as known in the art.

As shown in the figures, a solid or powdered flame suppressing additive, such as manganese dioxide/copper oxide catalyst available as Hopcalite®, provided by Drager of Germany for example, is added to a propellant bed inside a typical micro gas generator or any other gas generator. Other solid flame suppressants include powdered, granulated, extruded, or crushed transitional metals selected from the group including copper, iron, cerium, platinum, vanadium, zinc, zirconium, barium, lanthanum, manganese, nickel, molybdenum, rhodium, and palladium; an oxide of a transitional metal selected from the group including copper, iron, cerium, platinum, vanadium, zinc, zirconium, barium, lanthanum, manganese, nickel, molybdenum, rhodium, and palladium; an alkali metal such as sodium or potassium and a mixture containing two or more constituents selected from one or more of the groups including transitional metals, oxides of transitional metals, and alkali metals. The flame suppressant may also be carried by a substrate such as on ceramic beads. The metal materials may be in their normal metal form or ionic form.

The propellant bed therefore contains a primary propellant, and the flame or flash suppressing agent is essentially sprinkled or commingled amidst the propellant in heterogeneous relationship with the propellant. As such, the additive is not combined with the propellant into one composition, but instead augments the propellant to reduce the flame front without adversely affecting the gas generated. Stated another way, any known propellant within a propellant bed may incorporate a flame suppressant additive within the propellant bed wherein the propellant and the additive constitute distinct solid phases within the propellant bed. Accordingly, gas generating compositions need not be tailored to address customer requirements of flame propagation reduction. Rather, a flame suppressant additive may be added to a gas generator in any respective application thereby avoiding the need to redesign the gas generant responsive to customer requirements.

Given a basis of about 650 to 750 mg of gas generant or nitrocellulose, the amount or quantity of the flash suppressant additive generally ranges from 50-300 mg and eliminates or reduces the intensity of flash and/or flame output from the device in which the gas generator is installed. Stated another way, the gas generant is provided at about 65-98% by weight, and the additive is provided at about 2-35% by weight, whereby the weight percents are calculated with regard to the combined weight of the gas generant and additive combined within the propellant bed.

In practice, any gas generant contemplated for use within a gas generator is first evaluated for flame propagation. Flame propagation may be determined as given in Examples 1-11, or as given in Examples 12-15, but may also be determined as otherwise known in the art. Certain evaluations are a normal part of the development or design of gas generators as used in various contexts prior to customer approval. For example, the various characteristics of the combustion profile such as gas exit temperature, effluent content, total solids produced, and so forth are routinely determined as part of an airbag inflator gas generant development. Flame evaluation is also easily included in the evaluation, or, may alternatively be evaluated separately on an iterative basis depending on the type of gas generant composition. Accordingly, as the gas generant composition varies, the need for a flame suppressant additive may be determined as defined by customer requirements. The present invention therefore provides for addition of a flame suppressant as needed and as determined by preliminary evaluations that are a normal and well understood part of the design process.

In particular, seatbelt pretensioners, often included in a vehicle occupant protection system, realize particular benefit from the present invention. During a crash event, a seatbelt is automatically tensioned to tighten the slack of the seatbelt found during normal operating conditions. The housing of the seatbelt pretensioner is preferably designed to be relatively small, thereby reducing the overall weight of the seatbelt assembly and also reducing the raw materials and cost of each assembly. As such, the housing is not necessarily as robust and therefore may be damaged upon pretensioner activation.

Oftentimes, a more cost-effective gas generant or propellant is preferably used for relatively less complicated applications, within a micro gas generator in a seatbelt pretensioner, for example. U.S. Pat. Nos. 6,419,177, 6,460,794, and 6,520,443 are herein incorporated by reference and exemplify typical seatbelt pretensioners useful in vehicle occupant protection systems. Nitrocellulose exemplifies one typical propellant useful in seatbelt pretensioners. Exemplary benefits of the present application are illustrated in the examples given.

### EXAMPLES 1-11

For each example tabulated below, a seatbelt pretensioner as described in U.S. Pat. No. 6,213,513, herein incorporated by reference, was mounted on a rigid structure and fired open air, either unrestrained to permit pretensioning action or fixed for zero pretensioning. High speed video was used to detect and evaluate flaming external of the devices during pretensioner activation. The micro gas generator of the pretensioner was charged with about 700 mg of nitrocellulose. The amount of flame suppressing additive employed in each example, that is Manganese dioxide/copper oxide or Hopcalite®, is indicated in the table given below.

| | MnO₂/CuO | Nitrocellulose | Flame |
|---|---|---|---|
| Example | (mg) | (mg) | Duration (ms) |
| 1 | 0 | 700 | 2 |
| 2 | 0 | 700 | 2 |
| 3 | 0 | 700 | 1 |
| 4 | 0 | 700 | 13 |
| 5 | 0 | 700 | 1 |
| 6 | 0 | 700 | 1 |
| 7 | 0 | 700 | 1 |
| 8 | 0 | 700 | 1 |
| 9 | 150 | 700 | 0 |
| 10 | 150 | 700 | 0 |
| 11 | 150 | 700 | 0 |

As shown, a combustion flame is always apparent when the flame suppressing additive is not employed. However, when a flame suppressing additive is employed, a combustion flame does not result about the exterior of the pretensioner.

### EXAMPLES 12-15

Micro Gas Generator Vented Bomb Test—The micro gas generators of examples 12-15 are typically employed in pretensioners as described in Examples 1-11. Each micro gas generator of examples 12-15 was installed in a 10 cc bomb with a hole in the side, the hole sized to control the combustion pressure, such that it emulates the combustion environment typically found within a seatbelt pretensioner. The hole also functions to vent the combustion gases. The bomb was mounted to a rigid structure and fired open air. High speed video was used to detect and evaluate the flame emitted from the bomb vent, flame normally attendant to the combustion of the gas generant. The flame length is expressed in relative units as determined from the video. Accordingly, the examples show the relative lengths of the flame for comparative purposes.

| | MnO₂/CuO | Nitrocellulose | |
|---|---|---|---|
| Example | (mg) | (mg) | Flame Length |
| 12 | 0 | 700 | 76 |
| 13 | 0 | 700 | 71 |
| 14 | 150 | 700 | 59 |
| 15 | 150 | 700 | 53 |

Examples 12-15 indicate that the use of the flame suppressant results in a flame length about 24% shorter than indicated without the flame suppressant. Stated another way, examples 12-15 illustrate the ability to mitigate or reduce the flame front propagation normally attendant to combustion of the gas generator propellant.

The present invention may also be defined as a gas generating system to include the vehicle occupant protection systems defined above. In essence, the present invention includes a gas generator including a gas generant, wherein actuation of the gas generator results in a flame front upon actuation and combustion of the gas generant. It is believed that the addition of the flame suppressant additive may either reduce the total combustible products resulting from the combustion reaction, or may also function by reducing the gas exit temperature of the inflator thereby ultimately reducing the flame front resulting from combustion of the gas generant. To illustrate, examples 16 and 17 illustrate the reduction of carbon monoxide by adding Hopcalite to a bed of nitrocellulose.

### EXAMPLES 16 AND 17

Each micro gas generator of examples 16 and 17 was installed in a 10 cc bomb with a hole in the side, the hole sized to control the combustion pressure, such that it emulates the combustion environment typically found within a seatbelt pretensioner. The hole also functions to vent the combustion gases. The bomb was placed inside a 100 cubic foot chamber and fired. Effluents were measured using FTIR.

| | MnO₂/CuO | | CO ppm | |
|---|---|---|---|---|
| Example | (mg) | NC (mg) | 30 min TWA | CO ppm, peak |
| *16 | 0 | 700 | 75 | 83 |
| 17 | 150 | 700 | 60 | 61 |

*average of six tests

As shown above, the addition of the catalyst/flame suppressant Hopcalite results in a 15 to 20% reduction in carbon monoxide over time and at least 25% reduction at peak combustion. It is therefore believed that the reduction in carbon monoxide through catalytic oxidation of the same results in not only safer levels of carbon monoxide, but also a reduction in the flame propagation.

In accordance with the present invention, a preferred gas generating system includes a seatbelt pretensioner within a vehicle occupant protection system wherein the gas generant includes nitrocellulose and the additive includes the crushed or powdered Manganese dioxide/copper oxide catalyst as provided by Drager of Germany having the trade name Hopcalite®. Other manufacturers of powdered, crushed, or pulverized manganese dioxide and copper oxide includes Carus Chemical Co. at www.caruschem.com (Carulite® 300 Granular), and Molecular Products Limited at www.molecularproducts.co.uk (Moleculite®). Another preferred flash suppressant includes platinum, palladium, and tin oxide produced by Molecular Products Limited (Sofnocat). Yet another preferred flash suppressant includes manganese dioxide, copper oxide, and aluminum oxide also produced by Carus Chemical Co. (Carulite® 300 Extruded). The nitrocellulose is provided at about 650 to 750 milligrams within the gas generator propellant bed and the flash suppressant is sprinkled or distributed about the nitrocellulose within the propellant bed at about 30 to 150 milligrams.

In yet another aspect of the invention, a method of reducing the flame front and/or reducing carbon monoxide typically resulting upon actuation of a gas generating system is provided. The method includes loading a gas generator, one typically used within a vehicle occupant protection system or seatbelt assembly, for example. A propellant is inserted within a propellant chamber of the gas generator. Additionally, a catalyst is distributed within the propellant chamber either before or after inserting the propellant within the propellant chamber, wherein the catalyst is selected from the group consisting of transitional metals, transitional metal oxides, and mixtures thereof. Further, the catalyst is provided in an amount determined to reduce the carbon monoxide produced upon activation of the gas generator, wherein the catalyst or flame suppressant is commingled amidst the propellant in heterogeneous relationship with the propellant.

The flame suppressant is preferably selected from the group consisting of transitional metals including copper, iron, cerium, platinum, vanadium, zinc, zirconium, barium, lanthanum, manganese, nickel, molybdenum, rhodium, and palladium; transitional metal oxides selected from the group of oxides formed with metals selected from the group consisting of copper, iron, cerium, platinum, vanadium, zinc, zirconium, barium, lanthanum, manganese, nickel, molybdenum, rhodium, and palladium; an alkali metal selected from the group consisting of sodium or potassium; and a mixture containing two or more constituents selected from one or more of the groups selected from the group consisting of transitional metals, oxides of transitional metals, and alkali metals.

Further, the catalyst or flame suppressant preferably constitutes about 2 to 35% by weight and the gas generant preferably constitutes about 65 to 98% by weight, the weight percents based on the combined weight of the gas generant and the catalyst.

Finally, the gas generant constituents and the catalysts of the present invention are provided by known suppliers or manufactured as known in the art.

The present description is for illustrative purposes only, and should not be construed to limit the breadth of the present invention in any way. Although the present inflator is described as preferably including a nitrocellulose-based propellant within a micro gas generator of a seatbelt pretensioner, the principles of the present invention are applicable in other gas generating environments such as within an airbag inflator system as known in the art. It is therefore contemplated that the use of the additives characterized above could be employed in a vehicle occupant protection system by iteratively determining desired design criteria such as flame length or flame duration, the composition of the gas effluent, and other criteria as the amount of additive is varied in an otherwise identical airbag inflator. The amount of additive may be varied based on the required design criteria. Thus, those skilled in the art will appreciate that various modifications could be made to the presently disclosed embodiments without departing from the scope of the present invention.

What is claimed is:

1. A gas generating system comprising:
a gas generator for generating gas;
a propellant chamber within said gas generator;
a gas generant within said propellant chamber combustible to produce gas and a flame front; and
a flame suppressant distributed about said gas generant within said propellant chamber,
wherein said gas generant and said flame suppressant each defined a first and a second solid phase, respectively, said first and second solid phases distinct from each other, and, said flame suppressant reduces the flame front otherwise produced by the gas generator in the absence of said flame suppressant.

2. The gas generating system of claim 1 wherein said gas generant is nitrocellulose.

3. The gas generating system of claim 1 comprising a pretensioner.

4. The gas generating system of claim 1 comprising an airbag inflator.

5. The gas generating system of claim 1 wherein said gas generating system is a vehicle occupant protection system.

6. The gas generating system of claim 1 wherein said flame suppressant is selected from at least one member of the group selected from transition metals, transition metal oxides, and mixtures thereof.

7. The gas generating system of claim 1 wherein said flame suppressant comprises about 2 to 35% by weight and said gas generant comprises about 65 to 98% by weight, said weight percents based on the combined weight of the gas generant and the flame suppressant.

8. The gas generating system of claim 1 wherein said flame suppressant is selected from the group consisting of transitional metals including copper, iron, cerium, platinum, vanadium, zinc, zirconium, barium, lanthanum, manganese, nickel, molybdenum, rhodium, and palladium; transitional metal oxides selected from the group of oxides formed with metals selected from the group consisting of copper, iron, cerium, platinum, vanadium, zinc, zirconium, barium, lanthanum, manganese, nickel, molybdenum, rhodium, and palladium; an alkali metal such as sodium or potassium and a mixture containing two or more constituents selected from one or more of the groups including transitional metals, oxides of transitional metals, and alkali metals.

9. A gas generating system comprising:
a gas generator for generating gas;
a propellant chamber within said gas generator;
a gas generant comprising nitrocellulose, said gas generant contained within said propellant chamber and said gas generant combustible to produce gas; and
a flame suppressant distributed about said gas generant within said propellant chamber, said flame suppressant selected from one or more of the group consisting of transitional metals, transitional metal oxides, and mixtures thereof;
wherein said gas generant and said flame suppressant each defined a first and a second solid phase, respectively, said first and second solid phases distinct from each other, and, said flame suppressant reduces the flame front otherwise produced by the gas generator in the absence of said flame suppressant.

10. The gas generating system of claim 9 wherein said flame suppressant is selected from the group consisting of transitional metals including copper, iron, cerium, platinum, vanadium, zinc, zirconium, barium, lanthanum, manganese, nickel, molybdenum, rhodium, and palladium; transitional metal oxides selected from the group of oxides formed with metals selected from the group consisting of copper, iron, cerium, platinum, vanadium, zinc, zirconium, barium, lanthanum, manganese, nickel, molybdenum, rhodium, and palladium; an alkali metal selected from the group consisting of sodium or potassium; and a mixture containing two or more constituents selected from one or more of the groups selected from the group consisting of transitional metals, oxides of transitional metals, and alkali metals.

11. The gas generating system of claim 9 wherein The gas generating system of claim 1 wherein said flame suppressant comprises about 2 to 35% by weight and said gas generant comprises about 65 to 98% by weight, said weight percents based on the combined weight of the gas generant and the flame suppressant.

12. A method of manufacturing a gas generator to reduce carbon monoxide resulting from the combustion of a propellant within the propellant chamber of the gas generator, the method comprising the steps of:
inserting propellant within the propellant chamber; and
distributing a catalyst within the propellant chamber either before or after inserting the propellant within the propellant chamber, the catalyst selected from the group consisting of transitional metals, transitional metal oxides, and mixtures thereof, and the catalyst provided in an amount determined to reduce the carbon monoxide produced upon activation of the gas generator,
wherein the flame suppressant is commingled amidst the propellant in heterogeneous relationship with the propellant.

13. The method of claim 12 wherein the catalyst is selected from the group consisting of transitional metals including copper, iron, cerium, platinum, vanadium, zinc, zirconium, barium, lanthanum, manganese, nickel, molybdenum, rhodium, and palladium; transitional metal oxides selected from the group of oxides formed with metals selected from the group consisting of copper, iron, cerium, platinum, vanadium, zinc, zirconium, barium, lanthanum, manganese, nickel, molybdenum, rhodium, and palladium; an alkali metal selected from the group consisting of sodium or potassium; and a mixture containing two or more constituents selected from one or more of the groups selected from the group consisting of transitional metals, oxides of transitional metals, and alkali metals.

14. The method of claim 12 wherein the catalyst comprises about 2 to 35% by weight and the gas generant comprises about 65 to 98% by weight, the weight percents based on the combined weight of the gas generant and the catalyst.

15. The method of claim 12 wherein the propellant comprises nitrocellulose.
